(19) United States
(12) Patent Application Publication
(10) Pub. No.: US 2022/0178614 A1
(43) Pub. Date: Jun. 9, 2022

(54) KILN CONTROL

(71) Applicant: THERMAL RECYCLING (UK) LTD, West Midlands (GB)

(72) Inventors: Stephen John Beaumont, West Midlands (GB); Liam Wordley, West Midlands (GB)

(21) Appl. No.: 17/438,344

(22) PCT Filed: Mar. 11, 2019
(86) PCT No.: PCT/GB2019/000045

§ 371 Date: Sep. 10, 2021

(51) Int. Cl. F27B 9/40; F27B 9/36; F27D 99/00; F23N 1/02

(52) U.S. Cl. CPC F27B 9/40; F27B 9/36; F23N 2235/24; F23N 1/025; F23N 2235/10; F27D 99/0033

(57) ABSTRACT

A gas fired burner control system for a kiln for firing for instance ceramic items. The system including a plurality of operating modes, with the system being configured such that during a firing cycle the system can move between operating in different modes.

### CROSS-REFERENCE TO REATED APPLICATIONS

The present application is the U.S. national phase of International Application No. PCT/GB2019/000045 filed Mar. 11, 2019. The entire content of this application is incorporated herein by reference in its entirety.

This invention concerns a gas fired burner control system for a kiln, and also a kiln incorporating such a control system.

A wide range of products are fired in kilns, and particularly ceramic items. Different products require different firing conditions, for instance maximum temperatures, speeds of heating up and cooling down, and dwell times at particular temperatures. During the firing cycles for some products there is a requirement for excess air/oxygen to be present at certain points. For instance, excess air may be required when a binder or other volatile material is present, where a significant amount of carbonaceous material is present, and/or for certain glaze colours to achieve a required colour. Providing excess air can often lead to turbulence within a kiln, which in some instances is desirable, or may be required.

A number of products require very controlled firing. Such products can include for instance ceramic products useable in aircraft engines, and other technical ceramics. Also in processes such as firing asbestos waste to convert the material to a safe product, carefully controlled firing conditions are required. For instance it may be needed to start slowly to dry the product and also burn off packaging in which the product is supplied to avoid contact with such hazardous material. It is though necessary to ensure that all of the material has been safely converted

In kilns different amounts of heat may be required at different parts of the kiln. For instance more heat is generally required at a lower part of the kiln to heat the refractory, and also as heat rises. Generally less heat will be needed at ends of the kiln which include a refractory closure which will not require as much heating as product being fired.

Typically, in a firing cycle there are one or more heating periods (ramp), one or more dwell periods (soak), and a cooling period or periods. These require to be carefully controlled in duration, temperature levels and the rate of heating up or cooling down, as well as whether excess oxygen is required.

A wide range of gas fired kilns are used for firing a range of different ceramic or other products in batches or cycles. It is often required for kilns to fire different products at different times and hence be controlled differently, dependent on the products being fired at that time.

A wide range of different types of gas burners can be used, and burners are generally operated in one or more zones. Each zone includes at least one burner, though often a number of different burners are provided in each zone. Typically, a kiln will have a similar mode of combustion, and use a firing curve to best fit the required firing requirements. Such a firing cycle desirably provides repeatable and precise temperature control, and uniform temperature throughout the kiln and hence across the product.

The lowest possible fuel consumption and combustion emissions are also sought. Ideally the combustion control systems will require minimal maintenance and adjustment, and be easy to adjust. Generally, at least a certain amount of compromising is required to meet all these requirements using a single control mode for the combustion control system.

According to a first aspect of the invention there is provided a gas fired burner control system for a kiln, the system including a plurality of operating modes, with the system being configured such that during a firing cycle the system can move between operating in different modes.

In the operating modes, the gas and air supplies to a burner or burners are controlled as required. The operating modes may comprise two or more of the following:

First mode—excess air pilot pulse mode, where gas is pulsed through a pilot valve, with air being supplied in an amount to provide a significant excess amount of air beyond a stoichiometric mixture of gas and air;

Second mode—pilot pulse mode, where gas is pulsed through a pilot valve with air being supplied to provide an at least approximate stoichiometric level of gas and air;

Third mode—excess air main pulse mode, where gas is pulsed through a main valve, with air being supplied in an amount to provide a significant excess amount of air beyond a stoichiometric mixture of gas and air;

Fourth mode—main pulse mode, where gas is pulsed through a main valve with air being supplied to provide an at least approximate stoichiometric level of gas and air;

Fifth mode—fixed air mode, where air is provided at a fixed level, and the amount of gas is varied as required; Sixth mode—excess air ratio control mode, where the ratio of air and gas is maintained substantially constant, with air being supplied in an amount to provide a significant excess amount of air beyond a stoichiometric mixture of gas and air;

Seventh mode—excess air ratio control mode, where the ratio of air and gas is maintained substantially constant, with air being supplied in an amount to provide an at least approximately stoichiometric level of gas and air;

Eighth mode—excess air high/low mode, where the amount of air can be selectively provided at a relatively low level or a relatively high level, and switched between the low and high levels as required, with air being supplied to provide a significant excess amount of air beyond a stoichiometric mixture of gas and air;

Ninth mode—high/low mode, where the amount of air can be selectively provided at a relatively low level or a relatively high level, and switched between the low and high levels as required, with an at least approximately stoichiometric level of gas and air.

The operating modes may comprise at least five of the above modes.

The system may be configured to provide different amounts of air and/or gas to burners in different zones within a kiln, and the system may operate in different modes for different zones, if required.

The system may be configured to permit automatic switching between different modes dependent on temperatures detected in a kiln or in particular zones in a kiln.

The system may include a pilot valve and a main valve for the gas supply, and may include two main gas valves. The pilot and/or main valves may be in the form of solenoids.

The system may include air and gas supply valves, which may be motorised.

The system may include a ratio regulator which regulates the amount of gas in response to the amount of air supplied to a burner or burners.

According to a further aspect of the invention there is provided a gas fired kiln incorporating a burner control system according to any of the preceding nine paragraphs.

The kiln may be a shuttle or a tunnel kiln.

The kiln may include a plurality of firing zones which can be controlled independently from one another by the system. Each firing zone may include one or more burners.

Embodiments of the present invention will now be described by way of example only and with reference to the accompanying drawings, in which:—

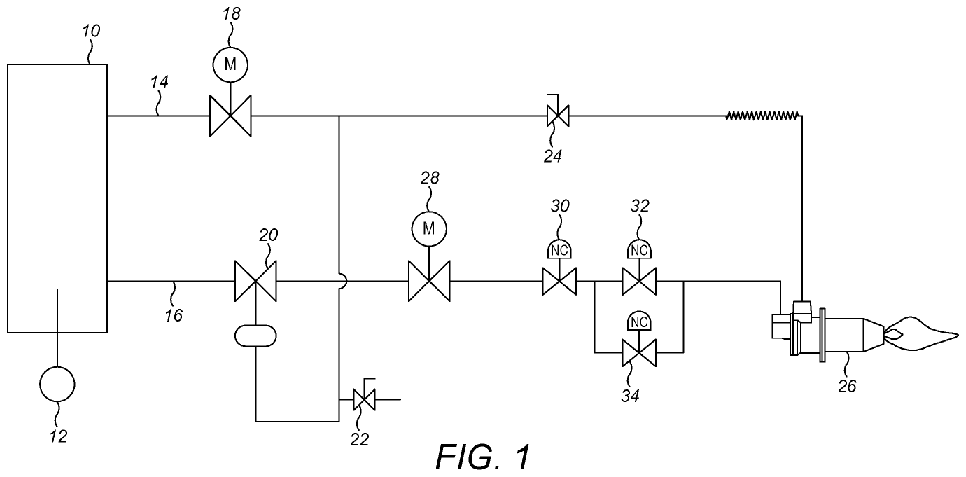

FIG. 1 is a schematic view of part of a gas fire burner control system according to the invention; and

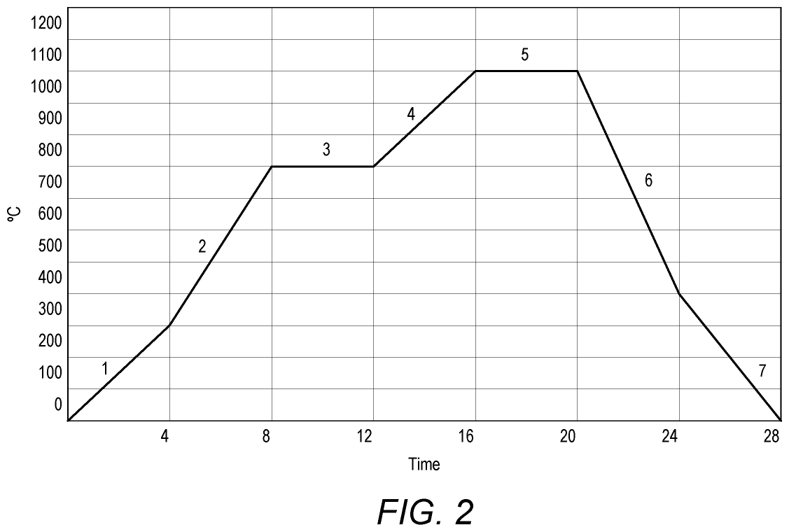

FIGS. 2 to 4 are respectively diagrams for examples 1 to 3, of use of the system of FIG. 1.

FIG. 1 shows diagrammatically a gas fired burner control system for a kiln for firing for instance ceramic items. The system comprises a controller 10 which is connected to a number of sensors 12 locatable in the kiln, and typically the kiln will be divided into a number of zones for firing purposes with at least one sensor 12 in each zone. The sensors may include a thermometer.

The system includes an air supply 14 and a gas supply 16. The air supply 14 includes a motorised air supply valve 18 with a connection downstream to a ratio regulator 20 which connects to the gas supply 16. A ratio bleed system 22 is provided for the ratio regulator 20. A manual air valve 24 is provided downstream of the air supply valve 18 and connection to the ratio regulator 20. From the manual air valve 24 the air supply leads to a burner or burners 26.

ownstream of the ratio regulator 20 the gas supply 16 leads to a motorised gas supply valve 28. Downstream of the motorised gas supply valve 28 is a first main burner solenoid valve 30. This leads to a second main solenoid valve 32. A pilot solenoid valve 34 is provided in a parallel loop bypassing the second solenoid valve 32. The gas supply 16 then connects to the burner or burners 26.

The system as controlled by the controller 10 may operate in nine different modes as required, as follows:

First mode—excess air pilot pulse mode, where gas is pulsed through a pilot valve, with air being supplied in an amount to provide a significant excess amount of air beyond a stoichiometric mixture of gas and air;

Second mode—pilot pulse mode, where gas is pulsed through a pilot valve with air being supplied to provide an at least approximate stoichiometric level of gas and air;

Third mode—excess air main pulse mode, where gas is pulsed through a main valve, with air being supplied in an amount to provide a significant excess amount of air beyond a stoichiometric mixture of gas and air;

Fourth mode—main pulse mode, where gas is pulsed through a main valve with air being supplied to provide an at least approximate stoichiometric level of gas and air;

Fifth mode—fixed air mode, where air is provided at a fixed level, and the amount of gas is varied as required;

Sixth mode—excess air ratio control mode, where the ratio of air and gas is maintained substantially constant, with air being supplied in an amount to provide a significant excess amount of air beyond a stoichiometric mixture of gas and air;

Seventh mode—excess air ratio control mode, where the ratio of air and gas is maintained substantially constant, with air being supplied in an amount to provide an at least approximately stoichiometric level of gas and air;

Eighth mode—excess air high/low mode, where the amount of air can be selectively provided at a relatively low level or a relatively high level, and switched between the low and high levels as required, with air being supplied to provide a significant excess amount of air beyond a stoichiometric mixture of gas and air;

Ninth mode—high/low mode, where the amount of air can be selectively provided at a relatively low level or a relatively high level, and switched between the low and high levels as required, with an at least approximately stoichiometric level of gas and air.

The nine modes can be achieved using the system as follows:

### Excess Air Pilot Pulse Mode

In this mode, the motorised gas valve 28 is trimmed to its lower position to allow for a stable flame at the burner 26. The motorised air valve 18 is opened to its highest position to allow for a stable flame at the burner 26. Upon demand for heat the first main burner solenoid valve 30 is fully opened, and the pilot valve 34 is pulsed on and off in proportion to the heat demand. Excess air is achieved by the balance of the setting on the motorised air and gas valves 18, 28.

### Pilot Pulse Mode

This is achieved in a similar manner to the excess air pilot pulse mode, but with the setting of the motorised air and gas valves 18, 28 being correspondingly changed to provide an approximately stoichiometric air and gas level.

### Excess Air Main Pulse Mode

Here the motorised gas valve 28 is set to a required fixed position, but not fully open. The main solenoid valves 30, 32 are opened and the burner 26 ignited. The motorised air valve 18 is then pulsed open and closed as heat is demanded, and the amount of opening may be limited by the controller 10. The amount of air provided is such as to provide an air to gas ratio well beyond a stoichiometric level.

### Main Pulse Mode

This will be similar to the excess air main pulse mode, but the motorised gas valve 28 may be more fully opened, and the motorised air valve 18 pulsed open to an appropriate amount to provide an approximately stoichiometric level of gas and air.

### Fixed Air Mode

The motorised air valve 18 is open to a required amount and remains open to that required amount, as dictated by the controller 10. The main solenoid valves 30, 32 are opened and the burner 26 lit. The motorised gas valve 28 is then modulated so as to provide a required amount of heating by allowing more gas to pass to the burner 26.

### Excess Air Ratio Control Mode

The motorised gas valve 28 is opened to a fixed position which is less than fully open. The main solenoid valves 30, 32 are opened and the burner 26 ignited. The motorised air valve 18 is then modulated under control of the controller 10, to provide an air to gas ratio well beyond a stoichiometric level.

### Ratio Control Mode

This is similar to the excess air ratio control but the motorised gas valve 28 is fully opened and fixed. The motorised air valve 18 is then modulated under control of the controller 10 to provide an approximately stoichiometric level of gas and air.

### Excess Air High/Low Mode

The motorised gas valve 28 is driven to a fixed position which is less than 100% open. The main solenoid valves 30, 32 are opened and the burner 26 ignites. The motorised air valve 18 is then opened either to a fixed high or a fixed low open position, to produce a high or a low flame in the burner 26, with an air to gas ratio well beyond a stoichiometric level.

### High/Low Mode

This is similar to the excess air high/low mode, apart from the motorised gas valve 28 is open to a fixed 100% open position, to provide an approximately stoichiometric level of gas and air.

The controller can be programmed as required to provide a firing cycle with a selection of any of the nine previous modes as required for particular products being fired, and for particular kilns.

In most instances kilns as indicated are divided into a number of different zones, and different modes may be applied to different zones as required. The system may be configured so as to be automatically movable between particular modes for some or all zones dependent on conditions sensed by the detectors 12.

### EXAMPLE 1

FIG. 2 shows a graph of temperature against time for a typical multimode firing cycle using a system according to the invention.

In considering the different modes.
1. This is a first ramp from ambient temperature to 300° C. in four hours using the first mode of the excess air pilot pulse. This provides a relatively gentle initial heat with excess air provided as may be required to deal with carbonaceous material, volatile materials which may be present, or for other reasons.
2. The ramp is increased for a further four hours from 300° C. to 800° C. using excess air main pulse mode.
3. There is then a soak at 800° C. for four hours again using the excess air main pulse as required to maintain the temperature.
4. There is a further ramp for four hours from 800° C. to 1100° C. using the ratio control mode which provides for the most efficient heating, and there is no longer a requirement for excess air to be present.
5. There is then a soak for 1100° C. for four hours.
6. There is then a first cooling from 1100 to 400° of 4 hours, with the rate of cooling being controlled by the air input to the burners.
7. There is then a second slower cooling from 400° to ambient in a further 4 hours, with again the cooling rate being controlled by air passing to the burners.

### EXAMPLE 2

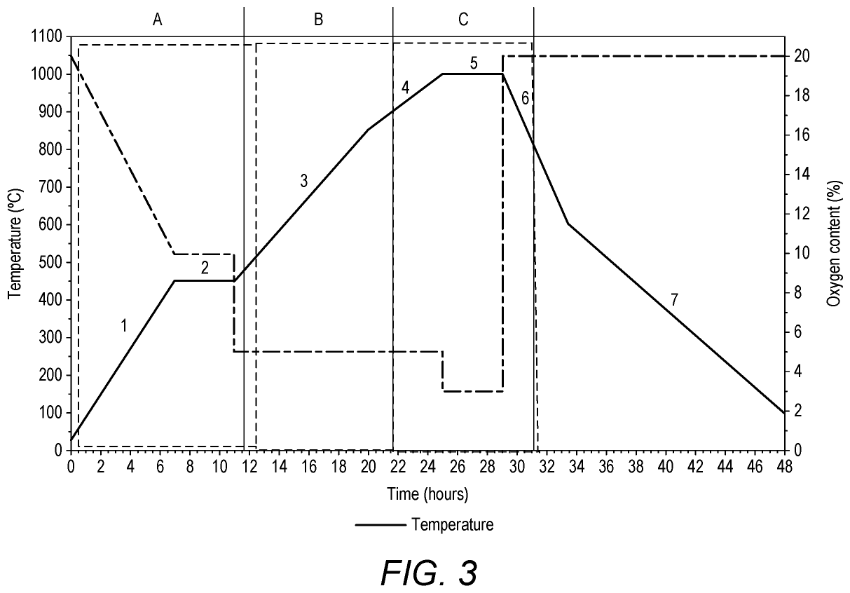

Drainage pipes are being fired, and the firing cycle is shown in FIG. 3 which also illustrates the oxygen content, indicating excess air when the oxygen content is at the usual level in air of around 20%, reducing down when required to approximately stoichiometric levels of around 2 to 4% oxygen content.

With such products dense loading patterns can be difficult to heat uniformly at the same heating rates. Potentially this can lead to large temperature differentials within the loads which can lead to “dunting” i.e. cracking and damage to the wear. To avoid such losses and damage dense loads often require a number of lengthy soaking periods at lower temperatures to enable the heat to penetrate evenly into the centre of the load. The firing cycle here is illustrated in FIG. 3 as follows.
1. Firstly there is a ramp to around 450° C. over around 6 hours using excess air main pulse mode (A) to provide sufficient heat, and with excess air as indicated.
2. There is then a soak for around 4 hours still using excess air main pulse to ensure that the load is heated throughout.
3. There is then a ramp up to the maximum firing temperature of around 1000° C. using ratio control mode (B).
4. The ramp is slowed down slightly and ratio control mode (C) is adopted.
5. This leads to a soak for around 4 hours still in the ratio control mode (C).
6. There is then cooling initially in ratio control mode (C), controlled by air input to the burner and subsequently with no heating in a first relatively steep cooling to around 600° C. As can be seen the oxygen level returns to an excess air situation.
7. This is followed by a shallower cooling for a further 14 hours or so, again controlled by air supply to the burner.

### EXAMPLE 3

Here a kiln is required to fire precision vitreous china, sanitaryware up to a maximum firing temperature of 1220° C., in a first firing cycle. This would be followed by a subsequent firing cycle.

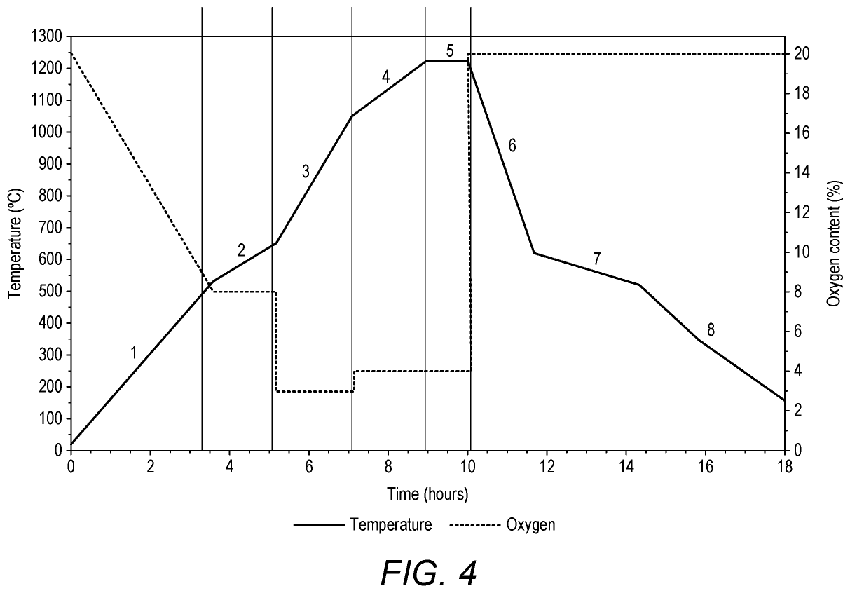

The kiln is configured with four temperature control zones split under and over each kiln car. FIG. 4 shows the firing cycle, again illustrating by a dotted line the oxygen content. The following firing cycle is used.
1. A first ramp of around 3 hours from 0 to 500° C. using excess air pilot pulse mode provides a relatively gentle heating, with excess air as required.
2. Excess air is not required now, and a gentler ramp is provided for a further 2 hours slow to around 650° C. using pilot pulse mode.
3. This is followed by a further steeper ramp using main pulse mode up to around 1000° C.
4. A shallower ramp is provided by using excess air main pulse mode for a further 2 hours to the maximum firing temperature of around 1220° C.
5. There is then a soak at maximum temperature for around an hour using fixed air mode.
6, 7, 8. There is then cooling in three phases, an initial steep cool (6) to around 600° C., followed by a much shallower cool (7) during a quartz contraction (inversion phase), followed by a more moderate cool (8), again using the air supply to control the cooling.

There are thus described gas fired burner control systems and kilns incorporating such systems which provide for a number of advantages. With such systems and kilns, improved production yields with reduced fuel consumption can be achieved. A high turbulence can be created in the kiln. The system can be used to provide improved temperature control. A more complete mixing and lower flame temperatures can be achieved. Superior temperature, uniformity and distribution can be obtained. A maximum heat transfer to the product whilst using a minimum amount of fuel.

The system provides a very flexible combustion control designed to provide very stringent temperature uniformity and application requirements. The system is very flexible and can be controlled or programmed as required for particular applications, materials and/or different kilns, and for different zones within the kilns.

The system and kilns can also be used in a wide range of applications including tableware products, sanitaryware, brick, tile and building products, and also in technical ceramics. Furthermore as indicated the system is ideally suited for use in kilns for the firing of asbestos or other waste materials to produce a non hazardous material.

It is to be realised that a wide range of modifications may be made without departing from the scope of the invention. For instance, a different range of operating modes may be used.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A gas fired burner control system for a kiln, the system including a plurality of operating modes, with the system being configured such that during a firing cycle the system can move between operating in different modes.

2. A control system according to claim 1, in which in the operating modes, the gas and air supplies to a burner or burners are controlled as required.

3. A control system according to claim 2, in which the operating modes comprise two or more of the following:
First mode—excess air pilot pulse mode, where gas is pulsed through a pilot valve, with air being supplied in an amount to provide a significant excess amount of air beyond a stoichiometric mixture of gas and air;
Second mode—pilot pulse mode, where gas is pulsed through a pilot valve with air being supplied to provide an at least approximate stoichiometric level of gas and air;
Third mode—excess air main pulse mode, where gas is pulsed through a main valve, with air being supplied in an amount to provide a significant excess amount of air beyond a stoichiometric mixture of gas and air;
Fourth mode—main pulse mode, where gas is pulsed through a main valve with air being supplied to provide an at least approximate stoichiometric level of gas and air;
Fifth mode—fixed air mode, where air is provided at a fixed level, and the amount of gas is varied as required; Sixth mode—excess air ratio control mode, where the ratio of air and gas is maintained substantially constant, with air being supplied in an amount to provide a significant excess amount of air beyond a stoichiometric mixture of gas and air;
Seventh mode—excess air ratio control mode, where the ratio of air and gas is maintained substantially constant, with air being supplied in an amount to provide an at least approximately stoichiometric level of gas and air;
Eighth mode—excess air high/low mode, where the amount of air can be selectively provided at a relatively low level or a relatively high level, and switched between the low and high levels as required, with air being supplied to provide a significant excess amount of air beyond a stoichiometric mixture of gas and air;
Ninth mode—high/low mode, where the amount of air can be selectively provided at a relatively low level or a relatively high level, and switched between the low and high levels as required, with an at least approximately stoichiometric level of gas and air.

4. A control system according to claim 3, in which the operating modes comprise at least five of the modes defined in claim 3.

5. A control system according to claim 2, in which the system is configured to provide different amounts of air and/or gas to burners in different zones within a kiln.

6. A control system according to claim 5, in which the system may operate in different modes for different zones, if required.

7. A control system according to claim 1, in which the system is configured to permit automatic switching between different modes dependent on temperatures detected in a kiln or in particular zones in a kiln.

8. A control system according to claim 1, in which the system includes a pilot valve and a main valve for the gas supply.

9. A control system according to claim 8, in which the system includes two main gas valves.

10. A control system according to claim 1, in which the system includes air and gas supply valves.

11. A control system according to claim 10, in which the air and gas supply valves are motorised.

12. A control system according to claim 1, in which the system includes a ratio regulator which regulates the amount of gas in response to the amount of air supplied to a burner or burners.

13. A gas fired kiln incorporating a burner control system, wherein the system includes a plurality of operating modes and is configured such that during a firing cycle the system can move between operating in different modes.

14. A kiln according to claim 13, in which the kiln is a shuttle or a tunnel kiln.

15. A kiln according to claim 13, in which the kiln includes a plurality of firing zones which can be controlled independently from one another by the system.

16. A kiln according to claim 15, in which each firing zone includes one or more burners.

17. (canceled)

18. A control system according to claim 2, in which the operating modes comprise the following:
First mode—excess air pilot pulse mode, where gas is pulsed through a pilot valve, with air being supplied in an amount to provide a significant excess amount of air beyond a stoichiometric mixture of gas and air;
Second mode—pilot pulse mode, where gas is pulsed through a pilot valve with air being supplied to provide an at least approximate stoichiometric level of gas and air;
Third mode—excess air main pulse mode, where gas is pulsed through a main valve, with air being supplied in an amount to provide a significant excess amount of air beyond a stoichiometric mixture of gas and air;
Fourth mode—main pulse mode, where gas is pulsed through a main valve with air being supplied to provide an at least approximate stoichiometric level of gas and air;
Fifth mode—fixed air mode, where air is provided at a fixed level, and the amount of gas is varied as required; Sixth mode—excess air ratio control mode, where the ratio of air and gas is maintained substantially constant, with air being supplied in an amount to provide a significant excess amount of air beyond a stoichiometric mixture of gas and air;
Seventh mode—excess air ratio control mode, where the ratio of air and gas is maintained substantially constant, with air being supplied in an amount to provide an at least approximately stoichiometric level of gas and air;
Eighth mode—excess air high/low mode, where the amount of air can be selectively provided at a relatively low level or a relatively high level, and switched between the low and high levels as required, with air being supplied to provide a significant excess amount of air beyond a stoichiometric mixture of gas and air; and
Ninth mode—high/low mode, where the amount of air can be selectively provided at a relatively low level or a relatively high level, and switched between the low and high levels as required, with an at least approximately stoichiometric level of gas and air.
